(19) United States
(12) Patent Application Publication
(10) Pub. No.: US 2006/0059701 A1
(43) Pub. Date: Mar. 23, 2006

(54) PLANE SURFACE POSITION LOCATOR

(76) Inventor: John Ronald Feemster, Saratoga, CA (US)

Correspondence Address: John Ronald Feemster, 18800 Ten Acres Road, Saratoga, CA, 95070, US

(21) Appl. No.: 10/711,465

(22) Filed: Sep. 20, 2004

(51) Int. Cl. G01B 3/14

(52) U.S. Cl. 33/562

(57) ABSTRACT

This patent is for a system for marking on large surface materials that aids in the material use and application where fasteners are applied through the surface, other materials are attached to the surface, or the large surface material is to be cut into a smaller parts. The markings are a coordinate pattern or patterns that can be attached to, printed on, or overlaid on a surface such that the markings give a visual surface location reference which aids in surface material applications. In operation the location marking(s) show relative location places where a fastener may be applied, another material may be placed, or a cutting plane may be done more accurately. The markings may be precise for a specific application or relative from surface edge-to-edge or/and top to bottom according to the material use. The marking(s) assist a visual surface location especially when the material surface is large and/or obscures associated materials behind the large surface used in conjunction with the larger surface material. Further, tools for marking large surfaces either are not readily available, are costly, or time consuming to apply when working with large surface area materials. The marking system gives easier, visual attachment accuracy, increases speed in material or fastener application for structural design integrity, or/and assists in the location of a cutting line when an application requires only a portion of the large surface material.

### BACKGROUND OF INVENTION

Large surface materials such as sheet stock, panels, siding, roofing, rolled materials, and the like, are used in a variety of ways requiring fastener attachment, applying other materials over them, or cutting the large surface material to a smaller piece. The very nature of a large surface presents a visual space problem in applications because the human eye does not readily identify specific surface locations, the relationship of a location relative to a surface edge, or a line parallel to a surface edge. The current practice in using large surface materials is to measure and mark locations on surface materials and/or estimate proper locations for fasteners, attachment places, or cutting lines. The marking of plane large surfaces is time consuming and subject to error according to how readily the surface is accessible.

Present building material panels do not have marking to assist in visual placing the fasteners so that attachment would be near the center of a supporting structure. The fastening of panel or large surface materials to supporting structures, such as plywood sheets, sheet rock, siding, metal sheeting, roofing sections, and the like, to framing, is often done relatively imprecisely since the panel surfaces obscure the framing structure from view where fasteners should be applied. Building structures fabricated using panel or sheet materials are optimum when fasteners are located through a panel at a specific place to the supporting structure and spaced in a uniform manner. Engineered designs as well as structure building codes depend on fastener location placement between panel materials and support structures to achieve an optimum assembly for strength. Building code panel attachments require designated fastener intervals for panels to framing structure to qualify the finished assembly for proper strength. To comply with the requirements, often requires the drawing of lines on the panels over framing for fastener locations. Fastener intervals are then estimated in an attempt to comply with the fastener spacing requirements.

Various devices have been used to help assist an individual's view of proper fastener location in attaching panels. These include applying chalk lines, pencil lines, and using a measuring instrument to determine a suitable fastener location. Each of these ways to determine fastener location is done manually on the panel material as it is used. To obtain good fastener placement at present requires that separate markings such as specific lines be placed on a material surface as fasteners are applied in a assembly buildup. These processes, while relatively effective, are time consuming and usually give visual assistance in only one dimension. Fastener spacing placement is still estimated. Random or estimated fastener application to large panel areas is imprecise and subject to placement error.

In other applications where large material surface areas are to have other materials applied over them, it is necessary to establish reference lines to obtain uniform material placement. Examples include the placement of square or rectangular tile, wallpaper, carpet, flooring, roofing, and the like on a surface. Time is taken to measure and determine a best starting point as well as subsequent material placement. As with the placement of fasteners, guidelines should be made on the large surface in order to establish visual references to obtain uniform placement.

When a large surface panel size exceeds the space to be covered such as plywood or sheet rock, obtaining an accurate cutting line on the plane surface entails measuring and using a squaring tool. The process is time-consuming adding to the cost of construction and installation. Pre-established accurate lines in sheet materials reduces the time to establish cutting lines even if the cutting plane were only a reference near existing accurate line(s).

### SUMMARY OF INVENTION

The present invention relates to a surface or panel material adapted to aid in locating a place for fasteners, other materials attachment alignment, or locating a cutting plane and particularly to one, which incorporates preprinted or attached line(s) or series of lines or marks that aid in the process of using materials. The lines are located such that intersections and/or the spacing of the lines provide a visual aid on a material surface, which serve as a reference location on the plane surface. The reference lines give a quick and easy relative surface location, which can be related to fasteners, material placement, or cutting planes. The line pattern, placed on the plane surface, provides location detail to assist in material use and application.

The present invention resolves the surface relationship problem(s) by pre-marking large surfaces with lines on the material surface and more specifically to markings having a quality to aid in particular surface location(s) on a large surface. The markings may show specific locations for a fastener or a general location series such as a grid of fastener locations relative to a surface side and/or edges. Fastener placement at a specific line intersection may not be needed where the pre-marked lines intersect when the lines are placed close enough to one another such that a relative ratio distance between lines is sufficient for relatively accurate fastener placement. The same placement location selection of other materials on a plane panel surface need not be specific at line intersections but could use a distance ratio near lines for material placement.

An example of PLANE SURFACE POSITION LOCATOR is with a common 4 foot by 8 foot plywood or chipboard sheet marked with reference lines appropriately spaced to give a relative location for nails or screws used to attach the panel to the structural stud members of a wall. Standard building codes prescribe the spacing of fasteners one to another as well as that they be placed where they are secured in a structural stud. Both the placement of the fasteners, and later, an inspection of fastener placement(s) are aided by a visual observation of fasteners applied and the PLANE SURFACE POSITION LOCATOR lines. Even in a situation where locater lines are not exactly over the stud, the selection of a fastener location in a relative position near a line or line intersection is more easily done and the quality of the finished attached panel is readily verified compared with a similar panel attached without the benefit of the PLANE SURFACE POSITION LOCATOR lines. In other instances such as wall sheet rock, rolls of metal, composite material, or any building material composed of large surface characteristics, using the PLANE SURFACE POSITION LOCATOR lines promotes more accurate location of fastener and material placement.

The PLANE SURFACE POSITION LOCATOR lines may be general or specific in their placement. The lines may be continuous, dashed, combinations of dashes, crosses, and lines, single or multiple colors, of different weighted thickness, and can include numerical markings showing the relative incremental distance and/or spacing between lines. The line placement on the surfaces may utilize increments of a general dimension or be specific consistent with a particular expected end use. The lines may be imprinted with permanent marking material such as ink, paint, or the like, or temporary material such as chalk, water solvable solution, or the like. The important feature of the PLANE SURFACE POSITION LOCATOR lines is to give an easily determined visual reference for material surface location.

### BRIEF DESCRIPTION OF THE INVENTION AND DRAWINGS

The following describes the drawings of plane surface material with the PLANE SURFACE POSITION LOCATOR imposed on its surface.

The PLANE SURFACE POSITION LOCATOR is a system of lines placed on a plane surface material to aid the placement of fasteners or other materials quickly and accurately without the need for additional markings or surface preparation. The lines may be general in nature with increments most common to a broad number of typical applications where the relative panel surface location is important or specific for special applications

The PLANE SURFACE POSITION LOCATOR is illustrated and defined in three figures. FIG. 1 depicts a typical plane surface panel with an enlarged detail showing the features of the PLANE SURFACE POSITION LOCATOR. Detail 11 shows a top view of a typical panel surface. Lines placed over the surface, 12, parallel to the edges and either crossing or containing an indicated crossing point give a reference position on the material surface. Using the surface position indicators, a fastener, 13 (typically a nail, screw, pin, or the like), could be placed easily by visual reference to the projected support structure location(s). The printed line intersections or a reasonable space between the lines give a visual reference location for a fastener, 13, in both the vertical and lateral location relative to another fastener, 13, and a support structure material, 14. A user selects appropriate fastener location(s) on an otherwise plane surface using the lines as a guide. The result is both vertical and lateral fastener placement quickly with position consistency. A visual inspection of a finished panel attachment indicates the quality of uniform fastener placement.

FIG. 2 illustrates a typical plane surface panel in a top view with an enlarged section, 21, as in FIG. 1. In this figure the lines placed over the surface parallel to the edges and either crossing or containing an indicated crossing point, 22, are used to locate the placement of a material, such as tile, 23, for attachment to the large surface. The printed lines on the material surface give a visual reference for the placement of additional tiles with relative location uniformity and consistency over the large surface area without the need of other tools or indicators. The reference lines show a vertical and lateral visual location reference throughout the large surface area.

FIG. 3 illustrates a typical panel surface, 31, in a top view with an overlay of lines, 32, placed over the surface parallel to the edges and either crossing or containing an indicated crossing point. This method of placing a line grid shows an alternate way to apply the reference surface locations. All methods of placing a grid on a surface, preprinted lines or marks, or overlay attached to the surface, and the like are effective to give a visual reference for material or fastener placement. Surface position location is subject to visual selection using the marks or lines as a guide for the variety of purposes where accurate location is important to the material use.

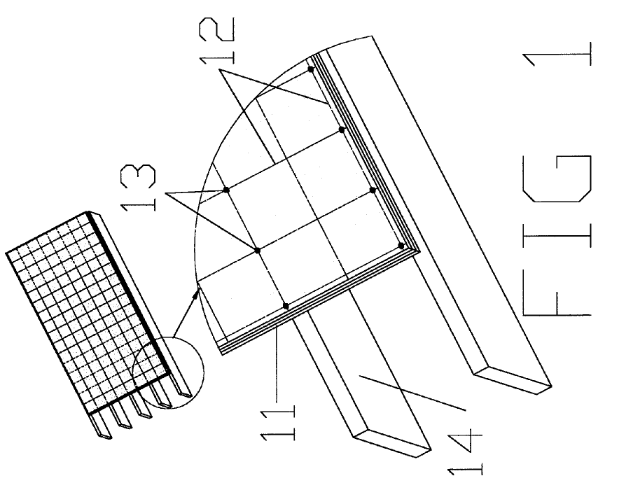

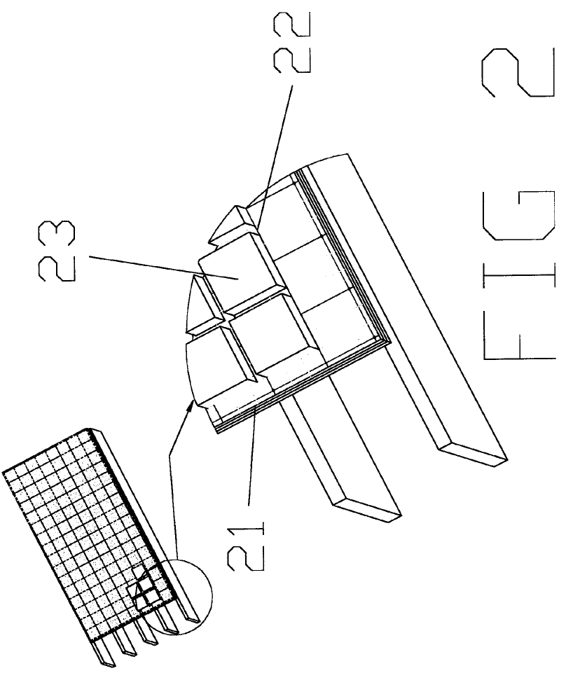

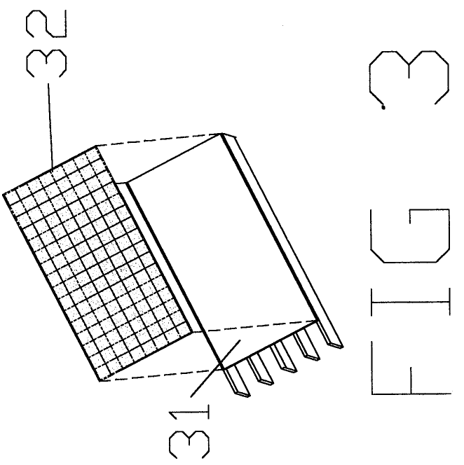

### OPERATION

An individual can easily interpret a large surface area for uniform placement of materials or fasteners with visual location aids. Common current practice to determine the location of attached materials or fasteners to a plane surface is to mark a surface with chalk or pencil lines in one direction only and proceed to estimate other direction placement or take the time to use other aids in selecting attachment placement Without such visual aids, material placement is subject to errors in uniformity, spacing, and alignment. The PLANE SURFACE POSITION LOCATOR on a material surface is effectively a grid or pattern, which provides a visual reference to locations on a surface where materials or fasteners can be placed to achieve a “best” placement. The effect of a preset grid of two-dimensional locations on a surface provides a ready visual reference to the surface, which can be quickly interpreted, for fastener or material placement. Further time for other visual placement aid is not needed in most cases. The two dimensional array provides an easy visual location reference for a surface where length and/or width location on the surface is important.

A secondary feature of the PLANE SURFACE POSITION LOCATOR is for locating a cutting a plane on a material more accurately for a ‘square’ cut. The two dimensional array provides location lines/marks with a ‘square’ reference to the sides. The line reference is accurate and easier to use without using other squaring tools.

What is claimed is:

1. An attached series of attention promoting lines or marks on surface materials composed of contrasting color(s) to the surface material, equidistant from the material surface edges, in spaced increments, which provide a visual reference suitable for the placement of other materials or fasteners relative to the surface material in length and/or width.

2. An attached series of attention promoting lines or marks on surface materials composed of contrasting color(s) to the surface material, equidistant from the material surface edges, in spaced increments, which provide a visual reference suitable for the uniform or ‘parallel’ cutting or size modification of a surface material in length and/or width.
